(19) United States
(12) Patent Application Publication
(10) Pub. No.: US 2013/0227018 A1
(43) Pub. Date: Aug. 29, 2013

(54) Methods and Systems for Identification in a Social Network Using a Mobile Telephone Number

(71) Applicants: Kevin Lawrence Regan, Chicago, IL (US); Robert Mark Turner, JR., N. Easton, MA (US)

(72) Inventors: Kevin Lawrence Regan, Chicago, IL (US); Robert Mark Turner, JR., N. Easton, MA (US)

(21) Appl. No.: 13/780,085

(22) Filed: Feb. 28, 2013

Related U.S. Application Data
(60) Provisional application No. 61/603,941, filed on Feb. 28, 2012.

(51) Int. Cl. H04L 12/58

(52) U.S. Cl. CPC H04L 51/32
USPC 709/204

(57) ABSTRACT

Systems and methods for social networking, in which a user of a social networking system may interact with other users, comprises using a processor to associate a telephone number, such as a cell phone number, with the user and to use the telephone number as an identifier of the user in the social networking system. A prospective contact may be identified with the telephone number of the prospective contact. The user may integrate access to multiple social networking systems by selecting one or more of the multiple networking systems as desired networking systems for the user's interaction with a contact. A contact may choose which of the multiple systems to select for interacting with the user. Further, contacts may be grouped in the networking system, and the user may present customized user profiles to contacts based on the groupings.

### CROSS-REFERENCE TO RELATED APPLICATION

This application claims priority to U.S. Provisional Application 61/603,941, entitled Methods and Systems for Identification in a Social Network Using a Mobile Telephone Number and filed Feb. 28, 2012.

### FIELD

The present invention relates to the field of social networking and particularly to the identification of individuals in the social network.

### BACKGROUND

It is in our innate nature to be socially interactive with each other; whether it be one person at a time or within a group. Interaction with other humans is a necessity. It is an important human behavior. Our Genus Homo ancestors relied on social interaction to find the best places to hunt, survive, and live. Without social interaction, our Genus Homo ancestors would have never survived or developed civilization.

The need for social interaction has become increasingly important as we humans evolve into our more sedentary lifestyle. One invention that helped to create more interaction was the telephone, created by Alexander Graham Bell. Telephony significantly impacted the way we socially interacted with people. The telephone allowed for instant connection between people who were thousands of miles away, allowing friendships to develop and business to be conducted far away from persons' homes and thus redefining what we think of as “local.” The invention of the mobile telephone, known popularly as the cell phone, has allowed people to make calls on the go, without having to use a traditional telephone, known popularly as the land line, which is connected to a network of other telephones and other devices by wire cable or fiber optics.

Mobile telephones have become increasingly sophisticated. Typically, they contain a phonebook which comprises a database containing a record for each of a user's contacts. Typically, the records contain contact information for the friend, including at least one telephone number and whatever particulars that the user may input into their contacts' records. Some phones contain capabilities that will allow the phone to be synchronized with a user's computer, so that the phonebook may be populated automatically with contact information from a user's computerized personal information manager such as Microsoft Outlook™ available from Microsoft Corporation of Redmond, Wash.

Technology has changed our lives again with the creation of the Internet. The Internet allowed people to send email messages instantly over this network, share files instantly, and connect to people all over the world in seconds. The development of software applications and online services such as those available through http://www.skype.com, now enable voice and video phone calls over the Internet.

With the formation of social networking websites like Friendster™ (www.friendster.com), MySpace™ (www.myspace.com), Facebook™ (www.facebook.com), and Google+™ (https://plus.google.com), the Internet has become the ultimate destination for social interaction. When people meet at a function and decide that they would like to get to know each other better, typically they exchange cell phone numbers. However, all things considered, the new friends have only won half the battle in our age of social networking. From there, they typically will go onto a social networking website with their new friend's name to find each other on-line. The task is easier said than done. The social networking website will display a list of people who may be his new friend based on the information that the user has input into the website. The user will need to sort through the list of names in order to find the new friend and send an invitation to be “socially linked.” In order for the process to be successful, the user will need a pretty good idea of the correct spelling of his new friend's first and last names to find the profile of his new friend. If he is lucky, the user will have an additional piece of identifying information about the new friend to use to aid in the search. This hunt and search process is not only tedious and time consuming, but it is also fraught with guesswork and uncertainty. What if the user spells the new friend's name wrong? What if the new friend name is spelled Alissa and not Alyssa? What if the user is searching for a person who studied at Boston University, when the new friend actually studied at Boston College? Or was it Babson College?

In the past, attempts have been made to integrate communication systems such as social interaction websites with personal telephones by populating mobile phones address books with contacts derived from the social network. Certain mobile applications, such as those for Facebook™ and Google+™, have developed a phonebook for a user. The phonebook comprises a database containing a record for each of the user's contacts, typically known as “friends.” Typically, the records contain information about the friend, including whatever particulars information that the social networking website may have on file for the friend. However, because the majority of users of social networking websites do not share their phone number via the Internet because of privacy issues, the phonebook developed by the social networking website may have hundreds, if not thousands, of contacts in their phone's address book without phone numbers. Users' mobile devices are flooded with an overload of contacts that they would normally not have or utilize on their mobile device.

When a person adds a phone number to his phone book, the record is more complete, but there is no social connection made. The social media application does not have the capabilities to recognize that a new phone number was added or to find the person on their social media website to prompt a connection. Similarly, when a person updates the phone book adds a new contact and phone number to his phone book, he will be able to make telephone calls, but there will be no connection on a social networking website between the person and his new contact.

While the social interaction websites have created mobile applications for their social networks, there are still flaws within their design and functionality. Typically, the mobile application will allow a user access to the social networking website on the display of his telephone, but the mobile application will not be linked to the user's telephone directory. Further, the mobile application still relies on the main website for its functionality, and does not provide the end user with a fully streamlined process. In addition, current social networking systems typically link users through a backwards process. If a user wants to use the social networking website to download telephone numbers, the people to be added to his telephone directory first have to be friends with the user on the social networking websites. The system may do an aggregate search for all the phone numbers of a user's friends, then input those numbers into a user's phone book.

Further, people accumulate a lot of “friends” on the social interaction websites. Many of these contacts are not close friends. In some instances, it has almost become a sign of social status to have a large number of “friends,” just to show that a person is really popular even though that person has no intention of communicating with most of the “friends.” On the other hand, a person tends to accumulate cell phone numbers from the people he actually wants to remain in contact with. The group of people whose cell phone number he possesses is the group of people he actually cares about. A social networs may flood a user with information about acquaintances which detracts from the user's ability to maintain a high level of communication with those people closest to him. The exclusivity of the personal address book, within the user's mobile phone, allows for the user to be connected to those that he really cares about.

Therefore, it is desirable to have a social interaction system that is simple, easy to facilitate, and takes into account the modern reality of our access to multiple types of technologically based communication methods.

### SUMMARY

An improvement is disclosed in computer-based social interaction systems in which a plurality of users may communicate with each other using computers interconnected through a social networking website, in which a user's telephone number serves as his identifier in the social interaction system. In one embodiment, the telephone number comprises a mobile telephone number.

The use of a user's telephone number to serve as a proxy for his social identity will allow for a more user friendly social media interaction. By using a user's telephone number as the identifier in a fully integrated social network, a discreet and intimate social community may be developed that is based upon the contacts that users enter into their phonebooks.

A telephone that may be connected to the network may have associated with it a processor having software to create a customizable profile page, and a display to display the profile page. The users' telephone numbers may serve as identifiers in the systems so that, after an exchange of telephone numbers with a new friend, a user may use the new friend's telephone number to easily identify the new friend on the system and request access to the new friend's profile. Similarly, the user's telephone number may be used by the new friend to identify the user and request access to the user's profile. Thus, the user's mobile number may now serve as a proxy for his social identity.

This streamlines social networking as we know it, because we will no longer have to access a social network and search for someone in order to be socially linked.

Methods and systems for social interaction, in which a user of the social networking system may interact with other users, are herein disclosed. The method may comprise associating, with an associating module, a telephone number with the user and using an identifier module and the telephone number as an identifier of the user in the social networking system. In certain embodiments, the telephone number comprises a mobile telephone number. In other embodiments, the method further comprises identifying a prospective contact with a prospective contacts module for the user with the telephone number of the prospective contact.

In other embodiments, the method comprises integrating, with an integration module, the user's access to multiple social networking systems by allowing the user to select one or more of the multiple networking systems as desired networking systems for the user's interacting with a selected or prospective contact. The selected or prospective contact may choose which of the multiple systems to select for interacting with the user.

In further embodiments, the method further comprises grouping, with a groups module, the selected or prospective contact in the networking system by allowing a user to select one or more groups of the networking system as desired groups for the user's interacting with a selected or prospective contact; and allowing the presentation of a customized user profile to the selected or prospective contact based on the selection of the desired groups.

A system for social networking, in which a user of the social networking system may interact with other users, may comprise a processor and a non-transitory computer-readable medium encoding instructions for social networking and for execution by the processor. The instructions may include one or more modules for executing the methods described above.

In other embodiments, a computer program for social networking, in which a user of the social networking system may interact with other users, may be embodied on a non-transitory computer readable medium. The computer program may comprise modules encoding interrelated and interdependent processes, including one or more modules, including an associating module and an identifier module. The computer program may be configured to perform the method described above.

The improvements to social networking here disclosed creates a system that revolves around the mobile number. Your mobile number now becomes your social identity. With the disclosed social network, the user will become “socially linked” once he inputs a new contact's number into his phone and his new contact approves the user's invitation. The social networking process becomes streamlined. In summary, by using the mobile number as disclosed, a more discrete and intimate social community may be created based upon the contacts that a user enters into their phonebook.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is a block diagram of an exemplary computer-based social interaction system;

FIG. 2 is a block diagram of a social networking application for use in the social interaction system in FIG. 1;

FIG. 3 is a block diagram of a mobile telephone application for use and that is used in conjunction with the social networking application of FIG. 2 in the social interaction system in FIG. 1;

FIG. 4 is a diagrammatic representation of a display on a user's telephone, showing a tab for displaying the profiles of a user of a social networking system supporting multiple groups;

FIG. 5 is a diagrammatic representation of a display for accessing multiple social networking systems;

FIG. 6 is a diagrammatic representation of a display of a new contact invitation form;

FIG. 7 is a diagrammatic representation of the display shown in FIG. 6, with the new contact invitation form customized to accommodate invitations to connect on multiple social networking systems; and

FIG. 8 is a diagrammatic representation of a display, showing a form for responding to an invitation to connect on multiple social networking systems.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

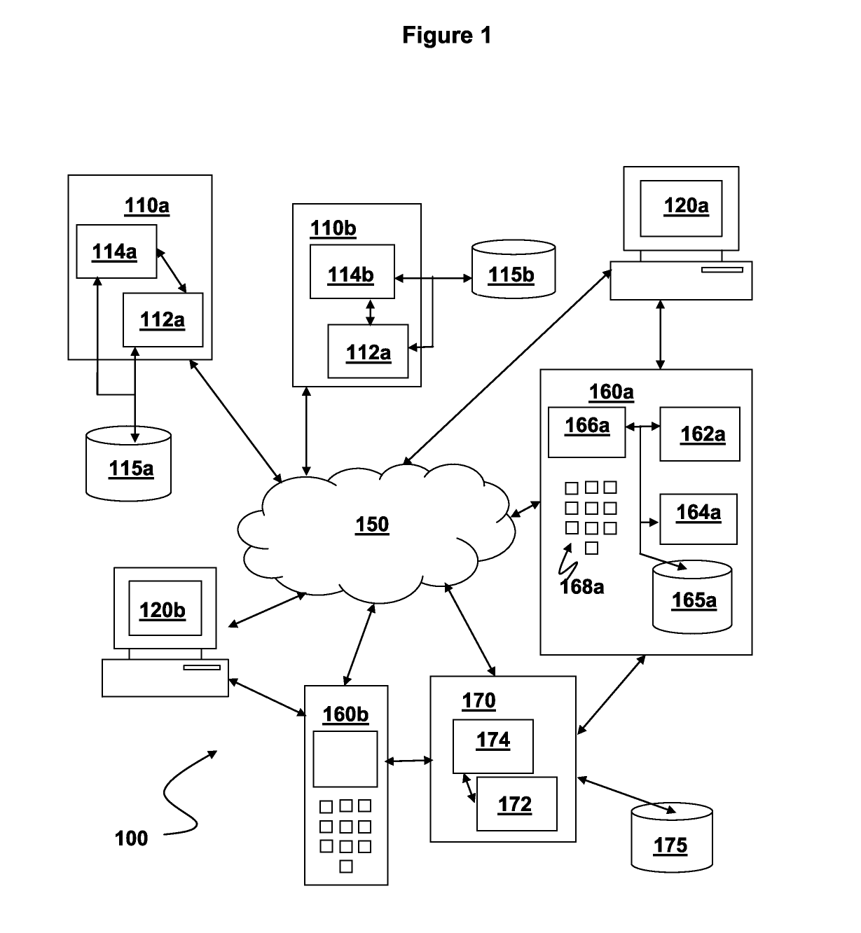

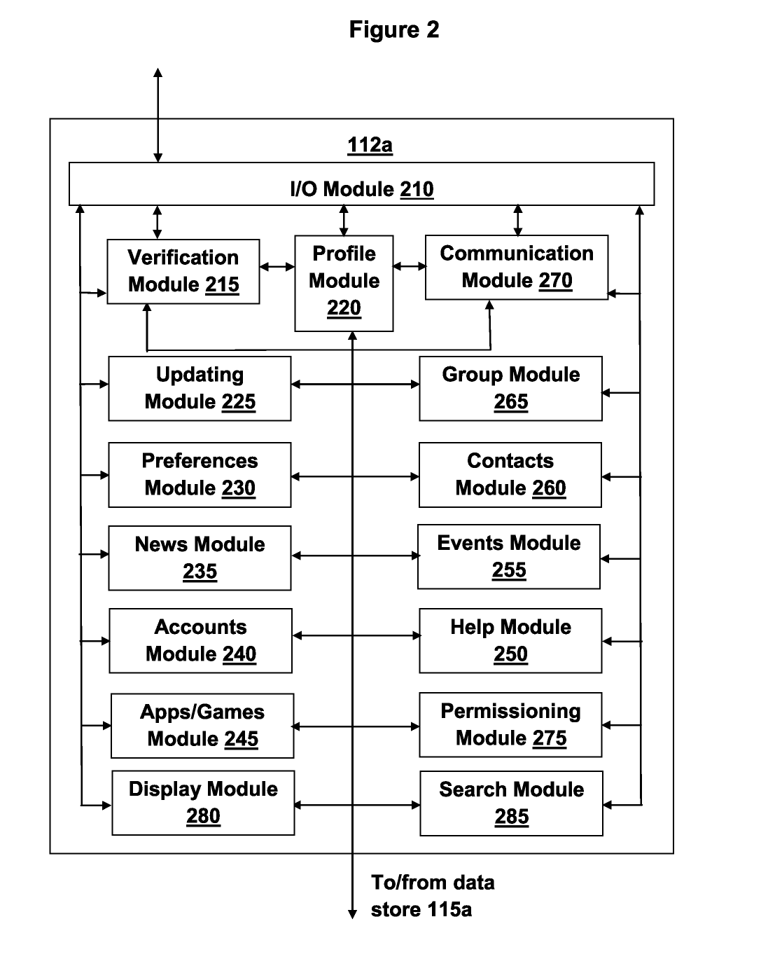

A computer-based social interaction system 100 according to the present invention will now be described in detail with reference to FIGS. 1 to 2 of the accompanying drawings. The social interaction system 100 has at least one processor such as a server 110a which hosts an application 112a for providing a social networking website 114a. The processor 110a has a storage unit 115a for storing instructions and data for operating the website 114a and populating the website with information about users of the network. The social interaction system 100 may have a second processor such as a server 110b which hosts an application 112b for providing a second social networking website 114b. The processor 110b may have a storage unit 115b for storing instructions and data for operating the website 112b and populating the website with information about users of the network. Users of the system 100 communicate with the servers 110a, 110b and access the social networking websites using their own computers such as computers 120a, 120b, which may be desktop computers, laptop computers, tablets, or any other conventional or known computing devices.

The application 112a may have an I/O module 210 to process communications to and from the processor 110a and a verification module 215 to verify user IDs and password. The application 112a may have a profile module 220 for developing a website profile page that may be customized to the user, and a display module 280 for facilitating the display of the website pages.

The application 112a may also have modules for providing other features, functionality, and pages of a website, such as module 225 for updating a user's profile photos, videos and links; module 230 for managing user preferences and account settings; module 235 for displaying news feeds from friends and contacts; module 240 for managing account settings; module 245 for managing games and applications; module 250 for managing help with the social networking website; module 255 for managing events and calendaring; module 260 for managing contacts in the social interaction network (sometimes known as ‘friends’); module 266 for managing groups and circles of contacts; and a module 270 for issuing and processing invitations to and from prospective friends and communicating with friends via chat, wall posts, or messaging.

The application 112a may also have a permissioning module 275 for managing user preferences as to the circumstances under which personal information may be shared, the circumstances under which linking to other users may be permitted, and the manner in which the linking is available. The profile may also have a search module 285 for identifying users to each other.

Users may also have a telephone such as a mobile telephone 160a, 160b that may communicate with their own computers 120a, 120b, respectively, and with a processor such as a server 170, which hosts an application 172 for providing a telephone system 174 that will allow telephones 160a, 160b to communicate with each other. The telephone system 174 may also allow processors 110a, 110b, 120a, and 120b to communicate with each other. The server 170 may have a storage unit 175 for storing instructions and data for operating the telephone system 174.

In addition, the user's telephone 160a may have a processor which hosts an application 162a for providing a personal telephone management system 164a with, among other features, a telephone directory, and for providing on-line access for the user. The telephone 160a may also have a display 166a for displaying the user's telephone directory and material accessed from on-line sources. The telephone may also have an integrated storage device 165a for storing instructions and data for operating the telephone 160a, for managing the user's telephone directory, and for managing the on-line connections. The telephone 160a may also have a keypad 168a for use in telephoning, texting, messaging, providing instructions to the telephone processor, and inputting other data.

The application 162a may have an I/O module 310 to process communications to and from the telephone 160a and a verification module 315 to verify user IDs and passwords. The application 162a may have a profile module 320 for providing instructions to the website profile module of customizing the website profile page to the user, and a display module 380 for facilitating the display of the website pages on the display 166a.

The application 162a may also have modules for providing telephoning functionality and for instructing the application 112a in providing customized features, functionality, and pages for the website, such as module 325 for instructing the module 225 in updating a user's profile photos, videos and links; module 330 for instructing module 230 in managing user preferences and account settings; module 335 for instructing module 335 in displaying news feeds from friends and contacts; module 340 for instructing module 240 in managing account settings; module 345 for managing games and applications and for providing instructions to module 245 in managing games and applications; module 350 for managing help with the telephone and accessing website help; module 355 for managing telephone events and calendaring and for accessing website events and calendaring; module 360 for managing a telephone directory and for instructing module 260 in managing contacts in the social interaction network; module 365 for managing groups and circles of contacts in the telephone directory and for instructing module 265 in managing groups and circles of contacts; and communication module 370 for providing telephoning functionality 360 such as receiving and making telephone calls, call waiting, and call forwarding, and texting functionality for the telephone 160a. The communication module 370 may also instruct module 270 in issuing and processing invitations to and from prospective friends and communicating with friends via chat, wall posts, or messaging.

In addition, the application 162a may also have a module 375 for instructing module 275 in managing user preferences for sharing personal information linking to other users, and the manner in which the linking is available. The application 162a may also have a module 385 for searching for information associated with the telephone and for instructing module 285 in identifying users to each other. In addition, the application 162a may have a synchronization module 390 to keep the user's telephone directory and the user's personal computer contact directory the same. The application 162a may also have an integration module 395 for managing the integration and concurrent operation of multiple social networking systems by the user and for displaying them concurrently or separately on the telephone display 168a.

The components depicted in the Figures may be operatively connected to one another via a network, such as the Internet 150 or an intranet, or via any type of wired or wireless communication system. Connections may be implemented through a direct communication link, a local area network (LAN), a wide area network (WAN) and/or other suitable connections.

One skilled in the art will appreciate that although only one or two of the components identified above is depicted in the Figures, any number of any of these components may be provided. Furthermore, one of ordinary skill in the art will recognize that there may be more than one telephone system 174 and server 170, and that functions provided by one or more components of any of the disclosed systems may be combined or incorporated into another component shown in the Figures.

One or more of the components depicted in FIG. 1 may be implemented in software on one or more computing systems. For example, they may comprise one or more applications, which may comprise one or more computer-readable instructions which, when executed by a processor, cause a computer to perform steps of a method. Further, while the modules are shown in the figures as associated with a specific processor, such as server 110a or telephone 160a, it is to be understood that the module may operate on any other processor shown or not shown. Further, the instructions for the module may be stored on the storage device associated with the specific processor or any other storage device, or they may be stored on one or more storage devices, and transferred to run on the shown processor or other or multiple processors. Computer-readable instructions may be stored on a computer-readable medium, such as a memory or disk. Such media typically provide non-transitory storage. Alternatively, one or more of the components depicted in FIG. 1 may be hardware components or combinations of hardware and software such as, for example, special purpose computers or general purpose computers. A computer or computer system may also comprise an internal or external database. The components of a computer or computer system may connect through a local bus interface.

The databases and storage units shown in FIG. 1 may be implemented as separate databases and repositories as shown in FIG. 1 or as one or more internal databases stored, for example, on the server 110. Storage unit 115 may be accessed by other components in system 100 directly via an external connection or via a network (not shown).

In operation, when the user wants to view his personal website page from a social networking system on the display of his processor system 120a or his telephone 160a, he sends a user ID and user password to the server 110a. The I/O module 210 receives the user ID and user password from the user, and communicates the user ID and user password to the verification module 215 of the application 112a. The verification module 215 communicates with the data store 115a to verify the user ID and user password (or other identifying data). The profile module 220 receives verification from the verification module and develops a website page that is customized to the user. The data used to create the personal website page may be communicated to the I/O module 210 to be displayed on a user's computer 120a or a user's telephone 160a, facilitated by the display module 280.

The website page may have a home page for the user, photos, favorite links, a list of friends, access to the user's friends, and other commonly known features of a social networking website. For example, the home page may display the user's name, employer, education, current location, hometown, birthday, and any additional contact information including an e-mail address. The user may also be able to add pictures to his profile that will be accessible to other users. The module 225 may allow a preferred picture to show up on a person's telephone or computer when the user calls or texts the person within his network, or when he messages them via the website. The preferred picture may also be associated with the user's name in the phonebook of people within his network.

The permissioning module 275 stores user preferences as to the circumstances under which personal information may be shared, the circumstances under which linking to other users may be permitted, and the manner in which the linking is available. For example, the user may choose to always allow updating on the network, to never receive invitations, to always allow invitations, or to allow a user to view invitations. One option may be a limited profile setting to allow people that a user is not connected with to only view a limited profile, containing, for example, the user's choice of information, such as a name, a business address, and/or a business phone number. In the limited profile setting, the access to a person's information will be limited to simply viewing the information that the user has selected by others to which the user is not connected. In another embodiment, the limited setting may also allow access to a person's photo. In a further embodiment, the permissioning setting may allow for messages and other communications to contain the user's name and optionally a photo to identify users to others.

The search module 285 may be used for identifying users to each other. The search module 285 receives search criteria input by a user and finds possible matches for the data based on the search criteria. One of the criteria may be a user's telephone number. In one embodiment, the search criterion may be a user's mobile telephone number. Thus, because the user's telephone is unique to the user, the user's telephone number may serve as a network identifier and will simplify search for a new friend or contact. The identifier may be stored in the data store 115a with other user information.

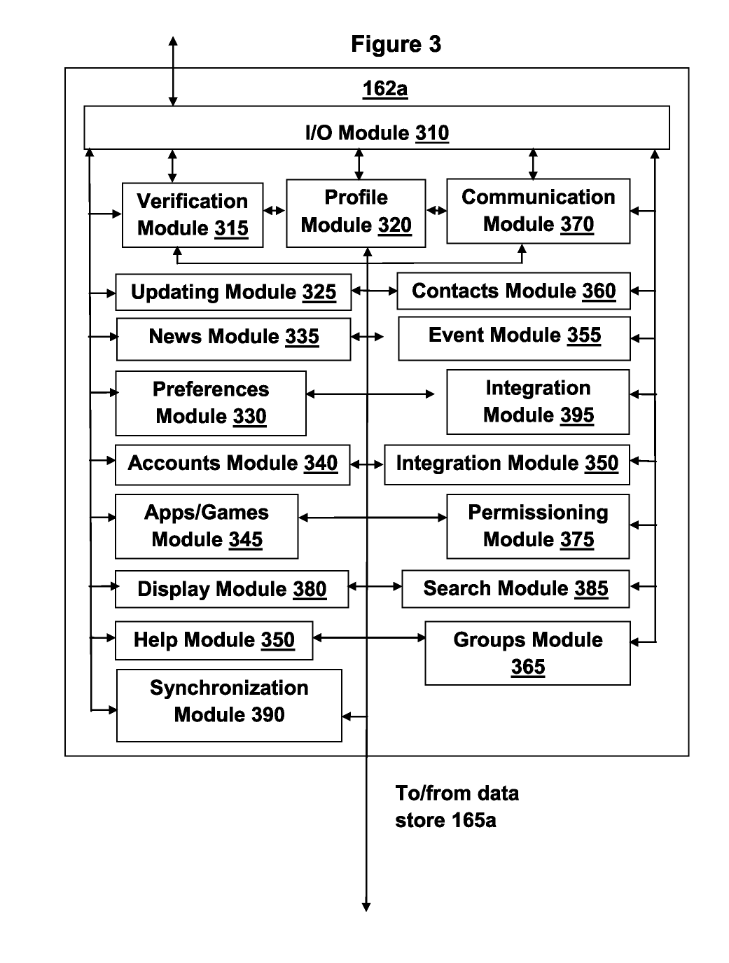

Referring to FIG. 3, the user ID and user password may be stored in the storage device 165a or input using the key pad 168a. They may be communicated to the server 110a using an I/O module 310. The verification module 315 may be used to ensure the authenticity of the data being received by the application 162a. The verification module 315 may communicate with the data store 165a to verify the data being received by the application 162a. The directory module 365 may manage a telephone directory and the profile module 320 may manage a website page that is customized to the user. The data used to create the personal website page may be received by the I/O module 310 to be displayed on the user's telephone display 166a facilitated by the display module 380.

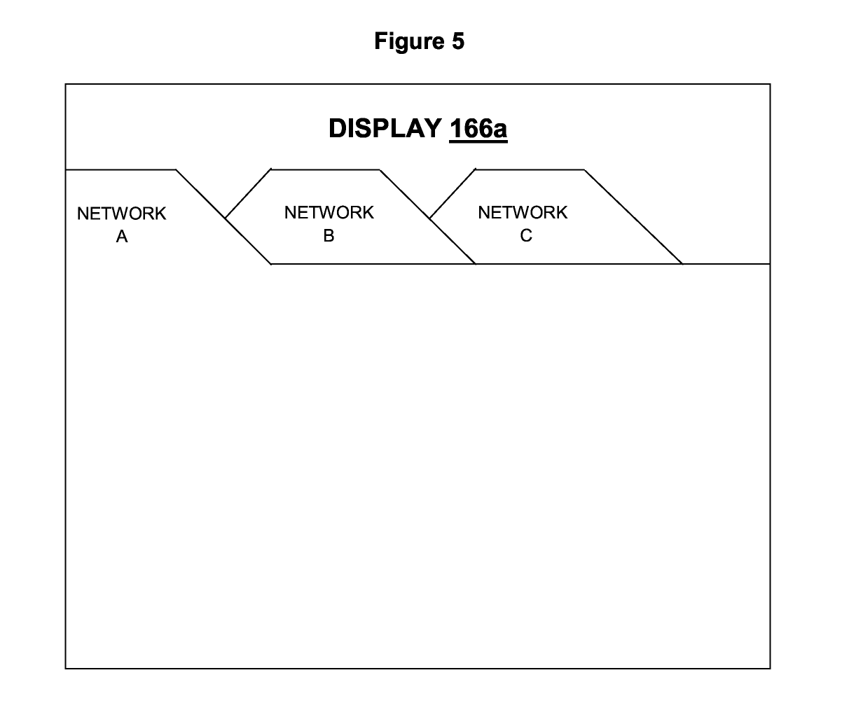

As shown in FIG. 5, a user's personal social interaction websites may be displayed on the telephone's display, with a tab for each of the social website systems with which the user is associated. The integration module 395 may access different social networking systems such as Facebook™, Twitter™, Google+™, etc. and, in association with the display modules 280, 380, display them on the telephone display 166a. The user may switch between social website systems by selecting an appropriate tab. So essentially instead of having to look at four or five different apps, a user may quickly and easily display the desired system and check multiple mobile applications in one location, thus eliminating the need to have multiple mobile applications to check.

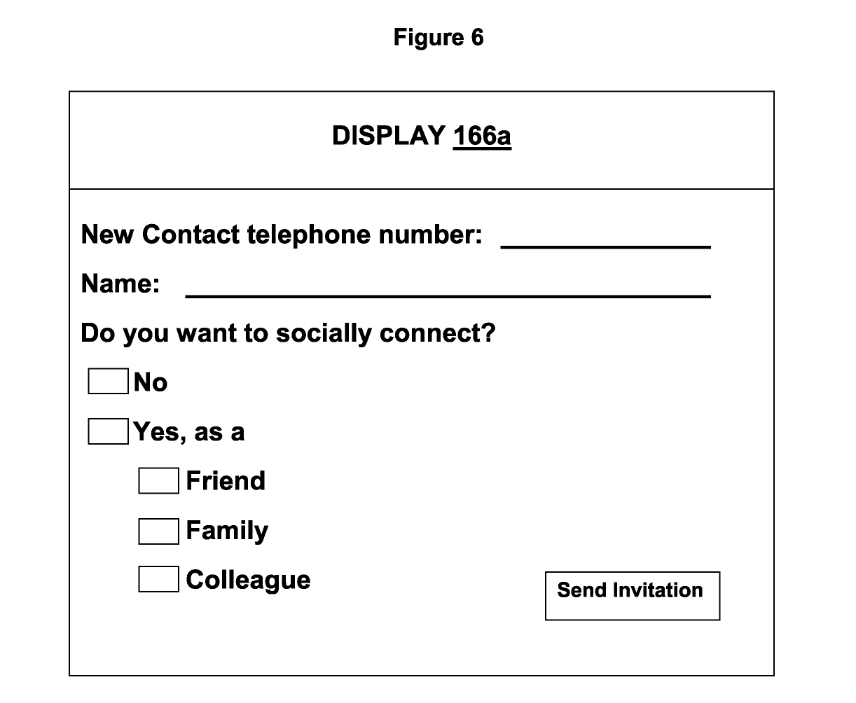

The contacts module 360 will work with the communications module 370 and the updating module 325 to update the user's telephone directory and, at the option of the user, to update the user's contacts on one or more of his social networking systems. In operation, when a user adds a new contact to his telephone directory, he will be prompted to select whether he wants to socially connect with this new contact. As shown in FIG. 6, the display 166a may present a new contact form with check boxes that the user may user may fill in his selections. The user may choose to not socially connect with the new contact, in which case the user may input the information about the new contact on the new contacts form. The contacts module 360 may then update the telephone directory.

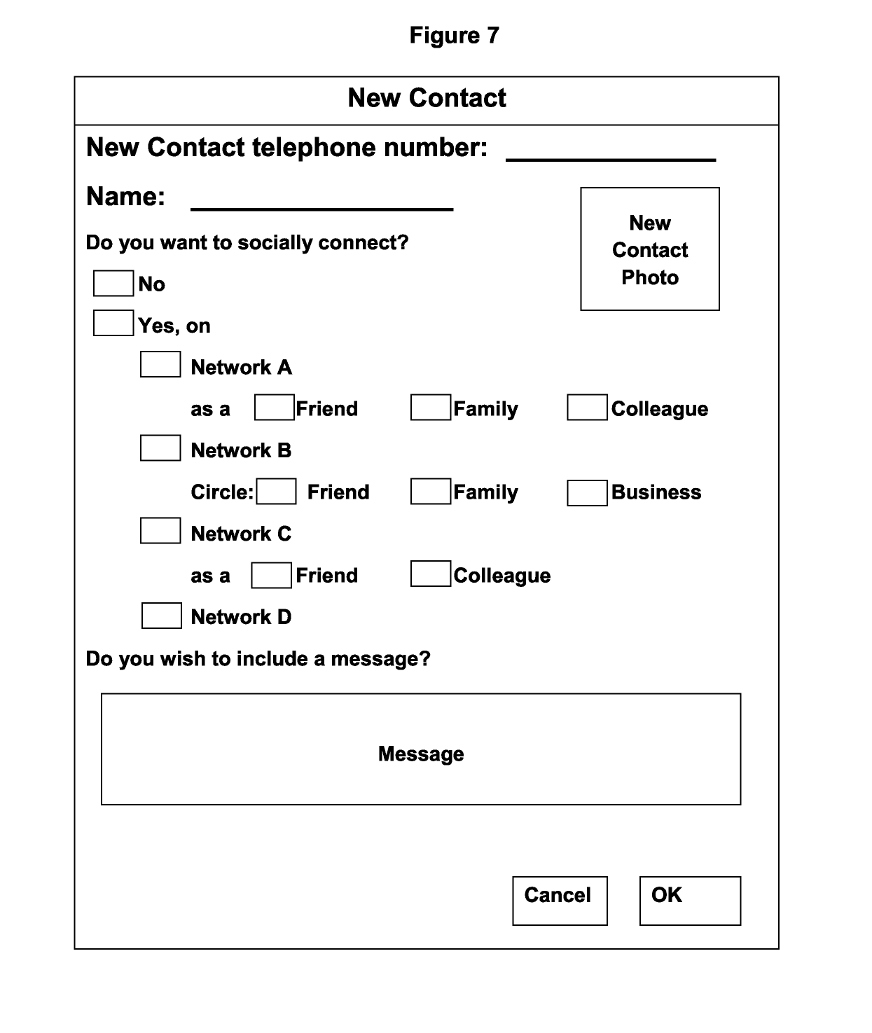

If the user does want to socially connect with the new contact, he would check “Yes” on the form, and then select the group (family, friend, or colleague) that is available on the system and into which he wants to place the new contact. If the user is a subscriber to multiple social networking systems, as shown in FIG. 7, the new contacts form may include check boxes for each of the user's social networking systems and the groups available with the selected system. Note that the groups may be different on each of the systems and that they may not be available at all on a social networking system.

When the user inputs a telephone number into the new contact form, the search module 380, with the communications module 370 and I/O module 310, sends a search request to the user's networks to discover whether the new contact is associated with any of the user's social networking systems. The search module 285 may operate with the contacts module 260 to search the network's subscribers by the telephone number. The search results will identify only one person, since mobile telephone numbers are unique to a person. The user's search module may communicate with the new friend's permissioning module in order to request friendship approval from the new friend.

The user may have chosen one of the networking systems to be a default system so that the search for the new contact is limited to or starts first with the default networking system. Alternatively, the search may be conducted through telephone directory assistance in the records of telephone system 170 or another telephone system.

If the telephone number is found among the network's subscribers and the person with which the number is associated has granted permission, via the system's modules 230, 240, and/or 275, for her name, number, and/or photo or other identifying information to be shared with other members of the networking system, the search module 285 will return (for example via I/O modules 210, 310 and communication modules 270, 370) the permitted information associated with the telephone number to the search module 385. The search module 385 will cooperate with the contacts module 360 and display module 380 to auto-fill the new contact's particulars into the new contact form of FIG. 7.

In one embodiment, the user may grant permission via the modules 230, 330, 240, 340, 275, and/or 375, to include the user's name, phone number, photo, and/or other identifying particulars on the invitation. Thus, the user may control the manner in which he is presented in his invitations. The user may also choose to include a personal message to the new contact. When the user is finished with filling in the new contact form, he uses the OK button to perform the actions selected on the form. If the user has so indicated, an invitation to socially connect with the user may be sent via module 210, 270 to the new contact.

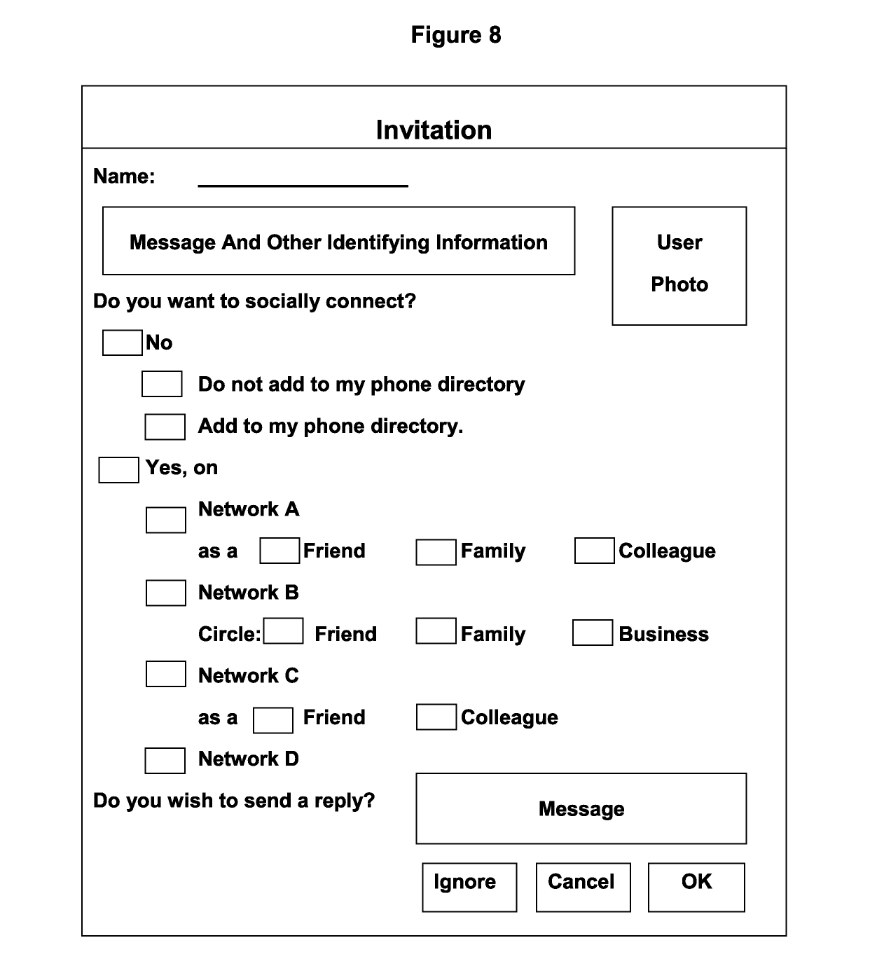

The new contact's permissioning module, in conjunction with the accounts module and the communication module, may provide privacy settings to allow for the invitation to not even be viewed by the new contact. If the new contact has approved the display of invitations, when the new contact receives the invitation, shown in FIG. 8, she may choose to ignore the message (by clicking, for example, on the Ignore button). She may choose to add the user to her telephone directory but reject the invitation to socially connect with him. If the new contact chooses not to connect to the user's social network, the new friend may still save the contact to his phone and view the limited profile of the user but not have access to the personal features within the user's social network.

She may also choose to approve the invitation by clicking on the check boxes for the user's networks with which the new contact is associated and through which she chooses to connect. If she selects a network to which she is not currently a subscriber, for example Network C, when she sends the invitation response to the user, the appropriate modules of the user's telephone application may send a subscriber instruction to the Network C. If she is a subscriber to a network that is not used by the user, for example a Network E (not shown), her response may include Network E and her response to the user may include an invitation to join Network E.

As with the user, the new contact may choose to include the user into the groups or circles of the networks to which the new contact subscribes. The groups to which the new contact assigns the user may be different than the groups or circles selected by the user for the new contact. Since the selected groups or profile determine which profile is viewable by a person's contact, the user and contact may choose to have each other view different types of profiles.

The new contact's permissioning module, in conjunction with the accounts module and the communication module, may provide privacy settings to allow for rejections of a user's invitation to be processed by the new contact, or to send a rejection to the user. The contacts application of the new contact and the user may keep records of invitations, rejections, and ignored invitations so that the involved parties can retrieve the past history for future reference. When the user's new contact approves the invitation of the user, the new contact's permissioning module may send an approval notification to the user's contacts module via the user's I/O module and communication module. The approval notification may be displayed on the user's telephone display or on the user's computer screen if the user is using his computer 120a to update the contact on the user's computer. If the user is using his personal computer, the computer's contact directory may be updated and the synchronization module 390 of the user's telephone application may be used automatically or manually to keep the user's telephone directory current.

Once approved, the user will gain access to his friend's profile in the manner elected by the friend in accordance with the friend's permission settings. The user may also gain access to other features included within their network such as status updates, group chats, views of what other places their friends have “checked in”, views of full profile for specified groups of friends, etc.

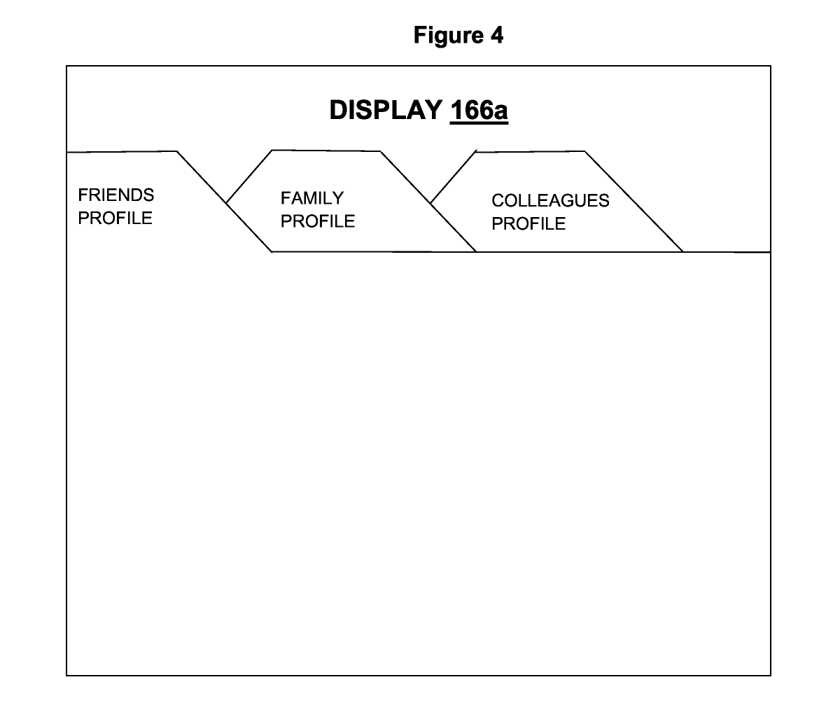

The groups modules 260, 360 may provide and manage classes or groups of contacts. Within the social interaction network, a user may differentiate between friend groups, i.e. work, family, and friend contact groups. Having levels of differentiation will only further the intimacy and exclusivity of the network. A user may have a customized profile for each group, so that each group has access to only the information to which the user wants the group to have access. As shown in FIG. 4, each of the customized profiles may be displayed on the user's telephone's display 166a, with a tab for each of the profiles that the viewer has created. The user may switch between profiles by selecting an appropriate tab. The new contact will only have access to the profile that the user wants the new contact to see.

The groups modules 265, 365 may provide any desired number of groups, such as the three basic groups identified above and the capability to create custom groups to differentiate contacts. Contacts are not necessarily limited to specific groups and may be present in more than one group as long as the user chooses to permit this. Therefore, the groups modules 265, 365, in communication with the permissioning module 275, 375 and the profile modules 220,320, may allow only members of a specific group to have access to that group's page. Therefore, a person in a user's “friends” group may have access to a selected profile and set of information, and the people who are in the “family” group will see an entirely different profile and set of information.

Within groups, a user may be able to receive personal messages and set up group chats. A user may elect, using the permissioning module with the communication module, to receive a name and a photo with every telephone call or text or with selected groups of messages, calls, or text, so that the user may better identify the people with whom he is communicating. This will allow a user to distinguish who is contacting him and determine if he would like to speak or otherwise communicate with the contact user (a caller ID with an image).

In both personal messages and group chats, people may be able to upload photos, videos, and web links etc. When the user opens his telephone directory, the contacts modules 260, 360 may operate with the groups modules 265, 365 to group contacts simply in alphabetical order or by the user's groups and display them, for example, in alphabetical order.

The user may access the social networking system on his telephone through his telephone directory, through his messaging systems, or through a browser screen provided by the telephone's Internet browser. In the embodiment in which the user has access to multiple networking systems, user may access a networking system through a screen provided by the integration module (FIG. 5). The integration module may display links to the multiple systems and tabs for the links, and the user may make his selection by selecting the associated tab. Similarly, the user may access the social networking website on his computer through his computer's contact directory, through his messaging system, through the Internet browser screen, or through a screen provided by the computer's integration module.

The updating modules 225, 325 may communicate with the display modules 280, 380 to display information related to recent activity by contacts. how recently a contact has visited or posted on a social interaction system. For example, in a directory or on a website page, the status update information may be displayed directly beneath the contact's name but above messages. When the user opens his telephone, the updating and new modules may operate to display the contacts who have posted new activity, be they be updates to the contact's profile, messages to the user, or any other activity accepted by the networking system. The recent activity may be displayed in a section of the first screen or in an update screen, Alternatively, the existence of updates may be displayed in the user's telephone directory or on the website pages by the contact's name being highlighted. The modules may provide a link to the updated material on or next to the highlighted name. The modules may allow for display of messages and communications from contacts by time (like a news feed) or by person or group. The news modules 235, 335 may communicate with the display modules 280, 380 to allow for display of status updates and messages under a contact's name. The grouping of communications by contacts rather than solely by “news feed” may allow a user to scroll quickly through recent updates and choose which updates and messages to read. The news modules 235, 335, in conjunction with the display modules 280, 380 may highlight the names of contacts with new updates and display the names of the new contacts above the names of contacts who have not recently updated their status. The definition of “recent” may be set as a range of times so that multiple updates may be classified as “recent.” In some embodiments, messages from more recent posters may be listed in alphabetical order.

The news module 235 may refresh updates within the contact list on a selected schedule or only when the user decides to reopen the address book. The news module 225 may also send a notification alert to a user via telephone text or email when the user receives a new message, is mentioned in a message, or tagged in a photo.

Thus, the application 162a may provide the user's phone book on the user's telephone as the centralized location for the different social media networks in the social interaction system 100. The address book module may integrate a user's personal profiles with multiple websites to allow for one single location for all social media networking to take place, thus creating a streamlined method of communication that encourages interaction with those closest that will to the user.

It may be seen that the embodiments of the systems and methods disclosed here may be used to greatly facilitate “linking” in computer-based social networks. The ability of users of a social interaction network to be found by their mobile numbers facilitates finding people. The uses of the cell phone number as a person's social identity also reduces the chances that the social network will have multiple users with identical names because cell phone numbers are unique identifiers already. Further, prompting a search by a social interaction system when a new phone number is saved to a user's contact list may streamline updating the user's contact directories (by auto-filling of information from the social networking system's records and by synchronizing of a user's computer contact directory and the user's telephone directory). It may also streamline finding new contacts and speed up the contact approval process. In addition, the integration of telephone and social networking technologies will provide quicker, more efficient social networking.

One of skill in the art will appreciate that the above-described stages may be embodied in distinct software modules. Although the disclosed components have been described above as being separate and consolidated units, one of ordinary skill in the art will recognize that functionalities provided by one or more units may be combined or separated, at the option of the developer. As one of ordinary skill in the art will appreciate, one or more of units may be optional and may be omitted from implementations in certain embodiments. For example, the computer 120a may have an application, not shown, having modules that are similar to the modules of application 162a in order to allow for the operation of the integrated website and telephone number linking features of the described system and methods.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments. For example, the described implementations may be implemented in software, hardware, or a combination of hardware and software. Examples of hardware include computing or processing systems, such as personal computers, servers, laptops, tablets, mainframes, micro-processors, and processing systems within so-called “smart” phones. It is intended that the specification and examples be considered as exemplary only, with a true scope and spirit of the invention being indicated by the following claims.

1. A system for social networking, in which a user of the social networking system may interact with other users, comprising:
a processor; and
a non-transitory computer-readable medium encoding instructions for social networking and for execution by the processor, the instructions including an associating module configured to associate a telephone number with the user and an identifier module configured to use the telephone number as an identifier of the user in the social networking system.

2. The system of claim 1, wherein the telephone number comprises a mobile telephone number.

3. The system of claim 1, further comprising a prospective contacts module configured to identify a prospective contact for the user with a telephone number of the prospective contact.

4. The system of claim 1, further comprising an integration module configured to integrate the user's access to multiple social networking systems,
wherein the integration module is further configured to allow selection by the user of one or more of the multiple networking systems as desired networking systems for the user's interacting with a selected or prospective contact; and
wherein the integration module is further configured to allow selection by the selected or prospective client of which of the multiple networking systems as the desired networking systems for interacting with the user.

5. The system of claim 1, further comprising a groups module configured to group a selected or prospective contact in the networking system,
wherein the groups module is further configured to provide selection by the user of one or more groups of the networking system as desired groups for the user's interaction with the selected or prospective contact; and
wherein the groups module is further configured to allow presentation of a customized user profile to the selected or prospective contact based on the selection of the desired groups.

6. A method for computer-based social networking, in which a user of a social networking system may use a computer to interact with other users, comprising
associating, using a processor and an associating module, a telephone number with the user; and
using the telephone number, by the processor and an identifier module, to identify the user in the social networking system.

7. The method of claim 6, wherein the telephone number comprises a mobile telephone number.

8. The method of claim 6, further comprising identifying a prospective contact for the user with a prospective contacts module and the telephone number of the prospective contact.

9. The method of claim 6, further comprising integrating the user's access to multiple social networking systems with an integration module, and further comprising
allowing the user to select, with the integration module, one or more of the multiple networking systems as desired networking systems for the user's interacting with the selected or prospective contact; and
allowing the selected or prospective client to choose, with the integration module, which of the multiple networking systems to select for interacting with the user.

10. The method of claim 6, further comprising grouping a selected or prospective contact in the networking system with a groups module, by
selecting one or more groups of the networking system as desired groups for the user's interacting with the selected or prospective contact; and
allowing the presentation of a customized user profile to the selected or prospective contact based on the selection of the desired groups.

11. A computer program embodied on a non-transitory computer readable medium for social networking, in which a user of the social networking system may interact with other users, wherein the computer program comprises modules encoding interrelated and interdependent processes, including an associating module, an identifier module, and wherein the computer program is configured to perform a method comprising:
associating using a processor and the associating module, a telephone number with the user; and
using the telephone number by the processor and an identifier module, as an identifier of the user in the social networking system.

12. The computer program of claim 11, wherein the telephone number comprises a mobile telephone number.

13. The computer program of claim 11,
further comprising a a prospective contacts module for identifying a prospective contact; and
wherein the method further comprises identifying the prospective contact with with the prospective contacts module and a telephone number of the prospective contact.

14. The computer program of claim 11,
further comprising an integration module for integrating the user's access to multiple social networking systems, and
wherein the method further comprises
allowing the user to select, with the integration module, one or more of the multiple networking systems as desired networking systems for the user's interacting with a selected or prospective contact; and
allowing the selected or prospective client to choose, with the integration module, which of the multiple systems to select for interacting with the user.

15. The computer program of claim 11, further comprising a groups module for grouping a selected or prospective contact in the networking system; and
wherein the method further comprises
allowing the user to select, with the groups module, one or more groups of the networking system as desired groups for the user's interaction with the selected or prospective contact; and
allowing presentation, with the groups module, of a customized user profile to the selected or prospective contact based on the selection of the desired groups.
